(19) United States
(12) Patent Application Publication
(10) Pub. No.: US 2008/0294368 A1
(43) Pub. Date: Nov. 27, 2008

(54) SYSTEM AND METHOD FOR CALCULATING THE INTERNAL VOLUME OF A SOLID MODEL

(76) Inventors: Jun Wan, Cerritos, CA (US); Chee-Keong Chong, Irvine, CA (US); Guirong Shi, Shanghai (CN); JunBo Zhang, Shanghai (CN); Lei Yang, Shanghai (CN); Raymond Kok, Huntington Beach, CA (US)

Correspondence Address: Siemens Corporation;Intellectual Property Department, 170 Wood Avenue South, Iselin, NJ, 08830, US

(21) Appl. No.: 12/052,387

(22) Filed: Mar. 20, 2008

Related U.S. Application Data
(60) Provisional application No. 60/896,702, filed on Mar. 23, 2007.

(51) Int. Cl. G01B 21/28

(52) U.S. Cl. 702/156

(57) ABSTRACT

A system, method, and computer program for calculating internal volume of a solid model, comprising selecting a seed cube that is internal to a solid model; determining a plurality of surrounding cubes surrounding said seed cube; and calculating a boundary volume from said plurality of surrounding cubes, and appropriate means and computer-readable instructions.

### CROSS-REFERENCE TO RELATED APPLICATIONS

This Application claims priority to pending Provisional U.S. Application Ser. No. 60/896,702, filed on Mar. 23, 2007, which application is incorporated herein by reference in its entirety.

### TECHNICAL FIELD

The presently preferred embodiment of the innovations described herein relate generally to software applications. More specifically, the presently preferred embodiment relates to calculating the internal volume of a solid model.

### BACKGROUND

Volume calculation is known in the 3D CAD industry. To do so, a 3D CAD application extracts all internal faces from a solid model representing an assembly. The extracted faces are then “sewn” together to form another solid model that represents the internal empty volume of the assembly. The volume of that new solid body is then calculated to determine the internal volume of the original solid model.

This industry technique is time consuming and not robust given the following obstacles: (1) it is a manual process that includes hundreds or thousands of faces for extracting; (2) any defect in a sub-assembly can result in failure of the volume estimation process; and (3) when designs are changed the process needs to be re-run leading to decreased efficiencies.

What is needed is a system and method for calculating the internal volume of a solid model that improves upon and corrects the noted obstacles.

### SUMMARY

To achieve the foregoing, and in accordance with the purpose of the presently preferred embodiment as described herein, the present application provides a computer implemented method for calculating internal volume of a solid model, comprising selecting a seed cube that is internal to a solid model; determining a plurality of surrounding cubes surrounding said seed cube; and calculating a boundary volume from said plurality of surrounding cubes. The method, further comprising generating an internal volume solid model from said boundary volume. The method, further comprising orienting said boundary volume to coincide with an orientation of said solid body to formulate a volume height map. The method, further comprising generating a volume height graph from said volume height map. The method, further comprising determining whether a height value on said volume height map is at a sample point. The method, wherein said seed cube is determined by a selection mechanism. The method, wherein said seed cube is determined based upon a predefined property. The method, wherein said predefined property is a fluid reservoir. The method, further comprising refining to reduce said plurality of boundary cubes. The method, further comprising generating a facet model for said volume. The method, wherein said facet model is created from a plurality of inner boundary faces.

An advantage of the presently preferred embodiment is to provide a computer-program product tangibly embodied in a machine readable medium to perform a method for calculating internal volume of a solid model, comprising instructions operable to cause a computer to select a seed cube that is internal to a solid model; determine a plurality of surrounding cubes surrounding said seed cube; and calculate a boundary volume from said plurality of surrounding cubes. The computer-program product, further comprising instructions to generate an internal volume solid model from said boundary volume. The computer-program product, further comprising instructions for orient said boundary volume to coincide with an orientation of said solid body to formulate a volume height map. The computer-program product, further comprising instructions to generate a volume height graph from said volume height map. The computer-program product, further comprising instructions to determine whether a height value on said volume height map is at a sample point. The computer-program product, wherein said seed cube is determined by a selection mechanism. The computer-program product, wherein said seed cube is determined based upon a predefined property. The computer-program product, wherein said predefined property is a fluid reservoir. The computer-program product, further comprising refining to reduce said plurality of boundary cubes. The computer-program product, further comprising generating a facet model for said volume. The computer-program product, wherein said facet model is created from a plurality of inner boundary faces.

Another advantage of the presently preferred embodiment is to provide a computer implemented method for calculating internal volume of a solid model, comprising generating a voxel model of a space internal to a solid model; traversing said voxel model to determine a boundary volume having a plurality of boundary cubes; calculating a volume of said boundary volume; whereby said calculated volume is a depiction of said space internal.

And another advantage of the presently preferred embodiment is to provide a data processing system having at least a processor and accessible memory to implement a method for calculating internal volume of a solid model, comprising means for selecting a seed cube that is internal to a solid model; means for determining a plurality of surrounding cubes surrounding said seed cube; and means for calculating a boundary volume from said plurality of surrounding cubes.

Other advantages of the presently preferred embodiment will be set forth in part in the description and in the drawings that follow, and, in part will be learned by practice of the presently preferred embodiment. The presently preferred embodiment will now be described with reference made to the following Figures that form a part hereof. It is understood that other embodiments may be utilized and changes may be made without departing from the scope of the presently preferred embodiment.

### BRIEF DESCRIPTION OF THE DRAWINGS

A presently preferred embodiment will hereinafter be described in conjunction with the appended drawings, wherein like designations denote like elements, and:

FIG. 1 is a logic flow diagram of the method employed by the presently preferred embodiment;

FIG. 2 is an illustration of a 3D solid model;

FIG. 3 illustrates a cube traverse;

FIG. 4 is a flow chart for a cube traverse;

FIGS. 5a and 5b illustrate a seed cube selection;

FIG. 6 illustrates a Volume-Height graph;

FIG. 7 is a facet model of an inner volume;

FIG. 8 is an illustration of a solid model for an internal volume; and

FIG. 9 is a block diagram of a computer environment in which the presently preferred embodiment may be practiced.

### DETAILED DESCRIPTION OF THE PREFERRED EMBODIMENTS

The numerous innovative teachings of the present application will be described with particular reference to the presently preferred embodiments. It should be understood, however, that this class of embodiments provides only a few examples of the many advantageous uses of the innovative teachings herein. The presently preferred embodiment provides, among other things, a system and method for calculating the internal volume of a solid model using voxels. Now therefore, in accordance with the presently preferred embodiment, an operating system executes on a computer, such as a general-purpose personal computer.

### System

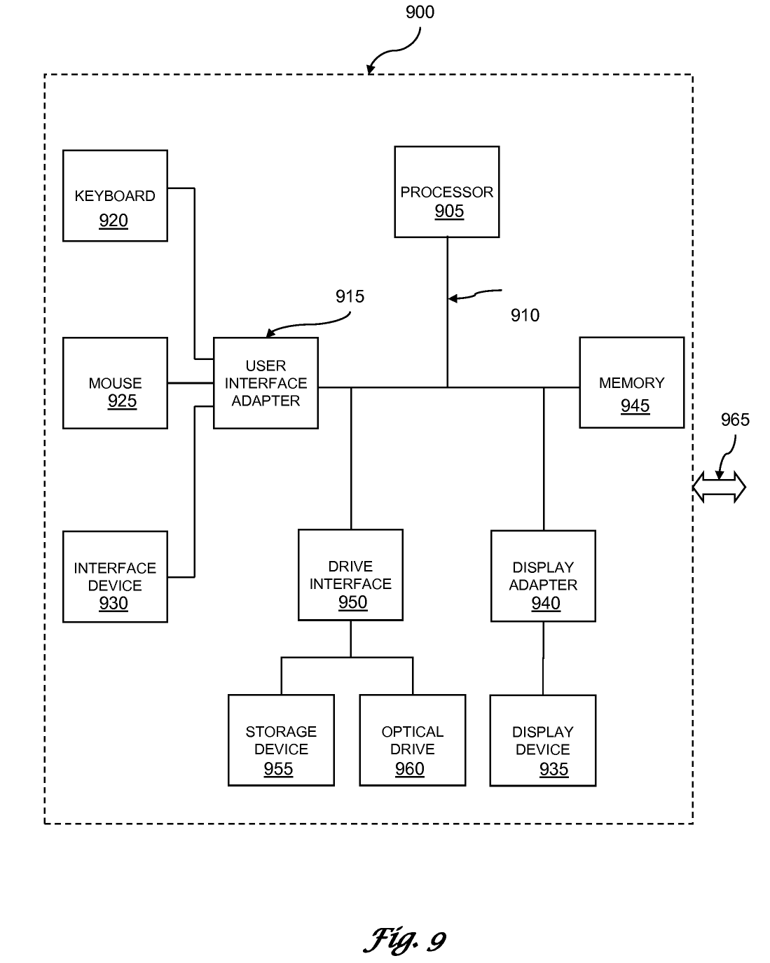

FIG. 8 and the following discussion are intended to provide a brief, general description of a suitable computing environment in which the presently preferred embodiment may be implemented. Although not required, the presently preferred embodiment will be described in the general context of computer-executable instructions, such as program modules, being executed by a personal computer. Generally program modules include routines, programs, objects, components, data structures, etc., that perform particular tasks or implementation particular abstract data types. The presently preferred embodiment may be performed in any of a variety of known computing environments.

Referring to FIG. 8, an exemplary system for implementing the presently preferred embodiment includes a general-purpose computing device in the form of a computer 800, such as a desktop or laptop computer, including a plurality of related peripheral devices (not depicted). The computer 800 includes a microprocessor 805 and a bus 810 employed to connect and enable communication between the microprocessor 805 and a plurality of components of the computer 800 in accordance with known techniques. The bus 810 may be any of several types of bus structures including a memory bus or memory controller, a peripheral bus, and a local bus using any of a variety of bus architectures. The computer 800 typically includes a user interface adapter 815, which connects the microprocessor 805 via the bus 810 to one or more interface devices, such as a keyboard 820, mouse 825, and/or other interface devices 830, which can be any user interface device, such as a touch sensitive screen, digitized pen entry pad, etc. The bus 810 also connects a display device 835, such as an LCD screen or monitor, to the microprocessor 805 via a display adapter 840. The bus 810 also connects the microprocessor 805 to a memory 845, which can include ROM, RAM, etc.

The computer 800 further includes a drive interface 850 that couples at least one storage device 855 and/or at least one optical drive 860 to the bus. The storage device 855 can include a hard disk drive, not shown, for reading and writing to a disk, a magnetic disk drive, not shown, for reading from or writing to a removable magnetic disk drive. Likewise the optical drive 860 can include an optical disk drive, not shown, for reading from or writing to a removable optical disk such as a CD ROM or other optical media. The aforementioned drives and associated computer-readable media provide non-volatile storage of computer readable instructions, data structures, program modules, and other data for the computer 800.

The computer 800 can communicate via a communications channel 865 with other computers or networks of computers. The computer 800 may be associated with such other computers in a local area network (LAN) or a wide area network (WAN), or it can be a client in a client/server arrangement with another computer, etc. Furthermore, the presently preferred embodiment may also be practiced in distributed computing environments where tasks are performed by remote processing devices that are linked through a communications network. In a distributed computing environment, program modules may be located in both local and remote memory storage devices. All of these configurations, as well as the appropriate communications hardware and software, are known in the art.

Software programming code that embodies the presently preferred embodiment is typically stored in the memory 845 of the computer 800. In the client/server arrangement, such software programming code may be stored with memory associated with a server. The software programming code may also be embodied on any of a variety of non-volatile data storage device, such as a hard-drive, a diskette or a CD-ROM. The code may be distributed on such media, or may be distributed to users from the memory of one computer system over a network of some type to other computer systems for use by users of such other systems. The techniques and methods for embodying software program code on physical media and/or distributing software code via networks are well known and will not be further discussed herein.

### Process

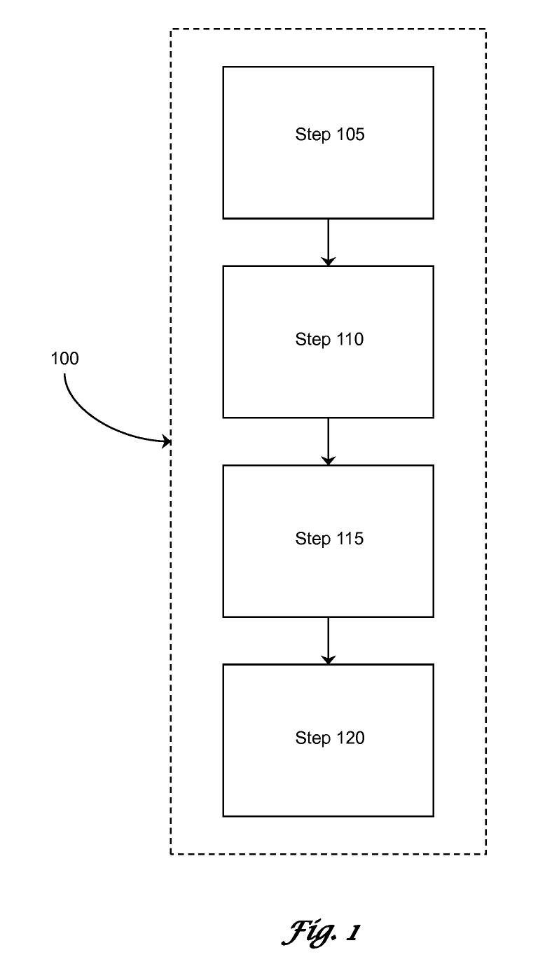

FIG. 1 is a logic flow diagram of the method employed by the presently preferred embodiment. Referring to FIG. 1, a computer implemented method for calculating the internal volume of a solid model using voxels is disclosed at 100. To practice the disclosed method, begin by selecting a seed cube internal to the solid model (Step 105). Next, determine a number of surrounding (or neighbor) cubes to the seed cube (Step 110). Then, calculate a boundary volume from the surrounding cubes (Step 115). Finally, generate an internal volume solid model from the volume information calculated (Step 120).

### Internal Volume Calculation

### Step 1

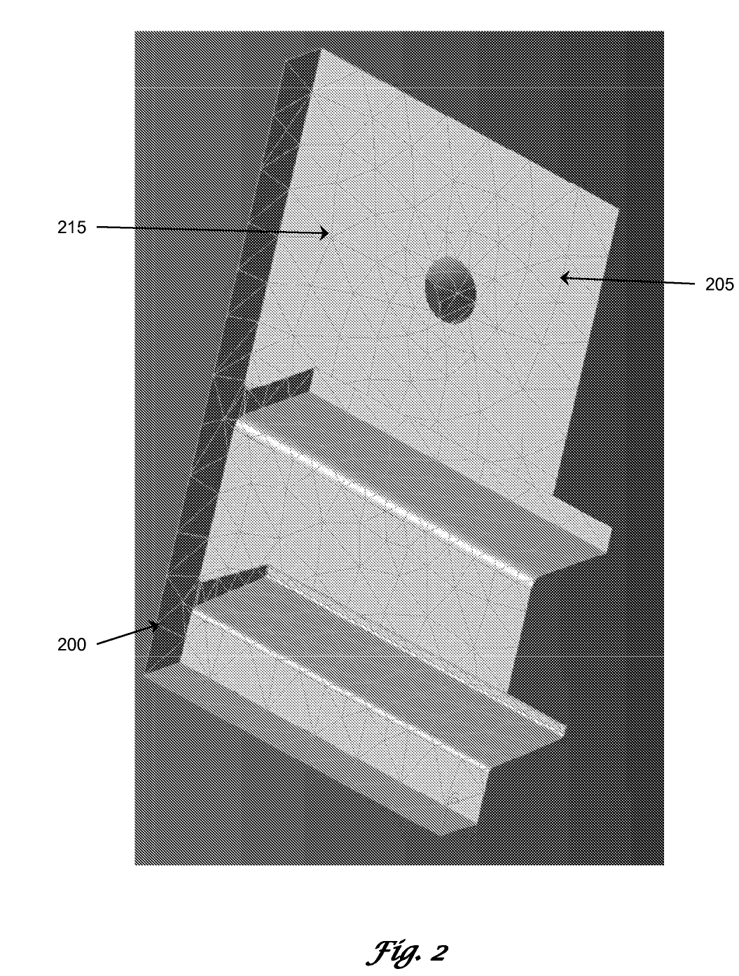

FIG. 2 is an illustration of a 3D solid model. Referring further to FIG. 2, a solid model 200 is a composite of boundary objects that form a solid body or sheet body in assembly. A 2D surface mesh 205 that may be faceted is created on each face of all boundary objects, where the user has selected specific closed solid or facet bodies of the solid model 200. The application that performs the presently preferred embodiment then obtains a plurality of vertices 215 from all of the mesh elements of the 2D surface mesh 205. The plurality of vertices 215 are now converted into a cube element for a voxel. If the coordinates of a vertex is [x, y, z], then the corresponding cube is [i, j, k] according to:

i=INT(x/L);

j=INT(y/L);

k=INT(z/L), where the cube size for a voxel is L×L×L. This process is repeated for all vertices 215 to produce a collection of cubes, or a boundary set, as a voxel model for a boundary representation of the interested internal space, where the boundary is defined by the solid model.

### Step 2

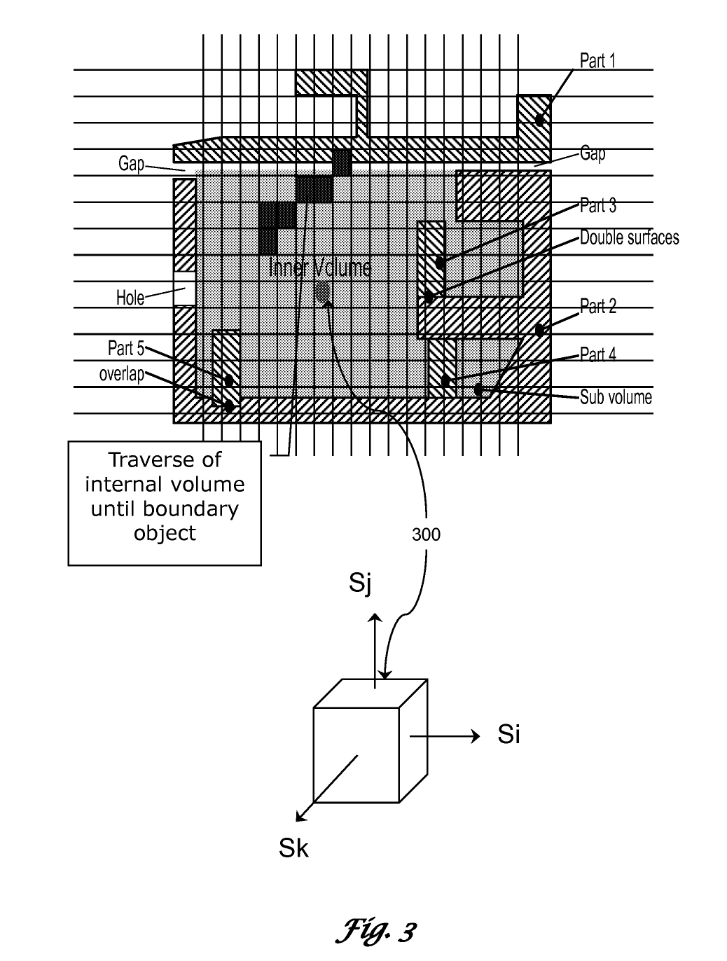

FIG. 3 illustrates a cube traverse. The user of the presently preferred embodiment specifies a start point to search the interested internal space. Referring to FIG. 3, the start point is a start voxel cube 300 with the coordinates [Si, Sj, Sk] according to:

Si=INT(Px/L);

Sj=INT(Py/L);

Sk=INT(Pz/L), where the user-determined voxel cube has the coordinates [Px, Py, Pz].

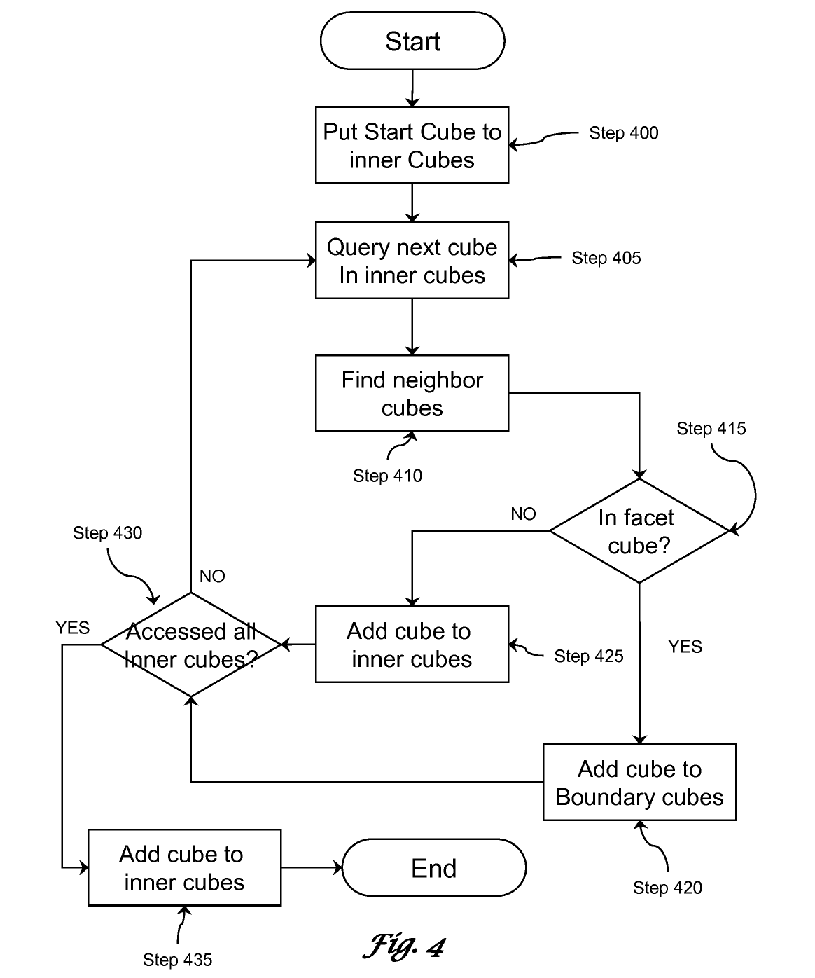

The start voxel cube 300, as with any voxel, has 6 faces, 8 corners, and 12 edges, which translates to 26 (=6+8+12) cubes surrounding the start voxel cube, according to the following coordinates: [(Si−1,Sj,Sk], [(Si+1),Sj, Sk], [(Si−1), (Sj−1), Sk], [Si, (Sj−1), Sk], [(Si+1), (Sj−1), Sk], [(Si−1), (Sj+1), Sk], [Si, (Sj+1),Sk], [(Si+1), (Sj+1), Sk], [(Si−1), Sj, (Sk−1)], [Si, Sj, Sk−1)], [(Si+1), Sj, (Sk−1)], [(Si−1), (Sj−1), (Sk−1)], [Si, (Sj−1), (Sk−1)], [(Si+1), (Sj−1), (Sk−1)], [(Si+1), (Sj+1), (Sk−1)], [Si, (Sj+1), (Sk−1)], [(Si+1), (Sj+1), (Sk−1)], [(Si−1), Sj, (Sk+1)], [Si, Sj, (Sk+1)], [(Si+1),Sj, (Sk+1)], [(Si−1), (Sj−1), (Sk+1)], [Si, (Sj−1), (Sk+1)], [(Si+1), (Sj−1), (Sk+1)], [(Si−1), (Sj+1), (Sk+1)], [(Si, (Sj+1), (Sk+1)], and [(Si+1), (Sj+1), (Sk+1)]. FIG. 4 is a flow chart for a cube traverse. Referring further to FIG. 4, the start voxel cube 300 is added to a VolumeSet (Step 400). Next, query a next cube in the VolumeSet (Step 405). Find the surrounding (or neighbor) cubes (Step 410). Determined the surrounding cube is a facet cube, put another way, whether the surrounding cube is in a boundary set (Step 415), where the boundary set was initially identified as specified by the user. If it is, then it is placed in a VolumeBoundarySet (Step 420), otherwise the surrounding cube is placed into the VolumeSet (Step 425). Next query whether all cubes in the VolumeSet have been accessed (Step 430). If not all inner cubes have been accessed then loop the query at Step 405. The last check is performed to determine whether each of its surrounding cubes as is in the boundary set. Regardless, if, all inner cubes have been access, then add the current inner cube to the VolumeSet (Step 435). Once no more new (or unique) surround cubes are found, then it is satisfactorily determined that all new surrounding cubes are in either the VoumeBoudarySet or the VolumeSet.

### Step 3

Next, calculate a volume of the internal space as determined from the VolumeBoundarySet, according to the following equations:

V_inner=V_cube*N_VolumeSet (Eq. 1)

V_boundary=V_cube*N_VolumeBoundarySet (Eq. 2)

where V_cube=L * L * L N_VolumeSet is the total number of cubes in VolumeSet, and N_VolumeBoudarySet is the total number of cubes in VolumeBoundarySet, so that the total volume of internal space, V, is:

V=V_inner+(V_boundary*50%) (Eq. 3)

### Step 4

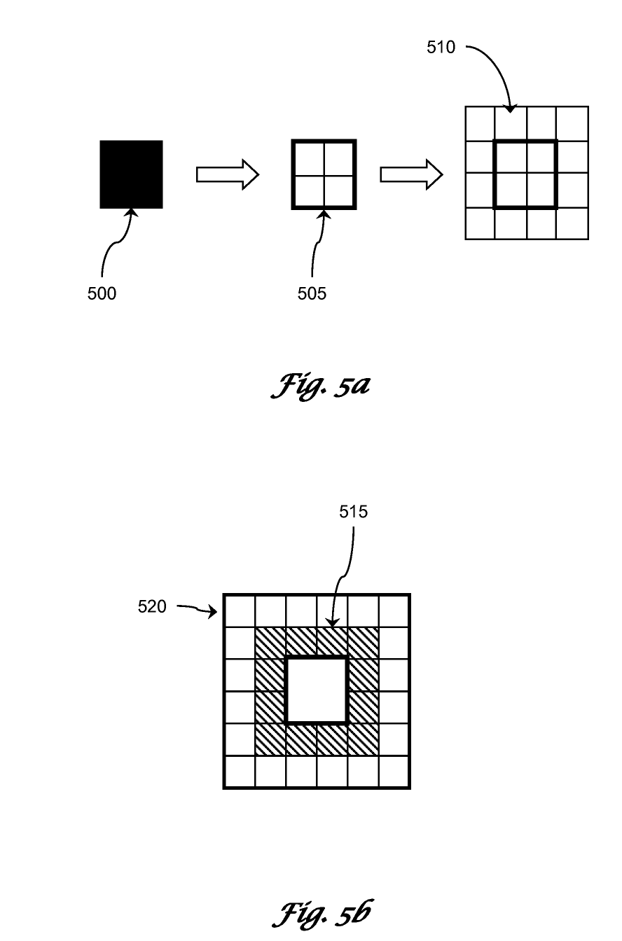

Optionally, the user can decide to further refine the boundary by reducing the size of the boundary cubes in half or quarter to gain more precision, if necessary. From the prior steps, inner cubes and boundary cubes were the same size, that is to say, they were the same volume. This step results in the creation of a RefinedBoundarySet. FIGS. 5a and 5b illustrate a seed cube selection in two dimension. Referring to FIG. 5a, a seed cube 500 is determined by the user. In the presently preferred embodiment, the seed cube 500 comes from the VolumeBoundarySet. The seed cube 500 may be refined for better precision, illustrated at 505, to form a refined boundary cube 510. If the refined boundary cube 510 is in an inner volume 515, it is stored in a TempSeedSet. Next, traverse the region between the actual boundary and the found inner volume 515 using all of the seed cubes 500 stored in the TempSeedSet. The seed cubes 500 stored in the TempSeedSet are used to search the additional boundary cubes to determine which are part of the inner volume cube set and which hare more precise boundary cubes. Referring to FIG. 5b, the 2D-view of the cube in the center is the original sized seed cube 500, and the outer 20 cubes, generally shown at 520, represent the new boundary after refinement. The refinement operation traverses from the seed cube 500 and searches the region between the seed cube 500 and 520, i.e., inner volume 515.

### Step 5

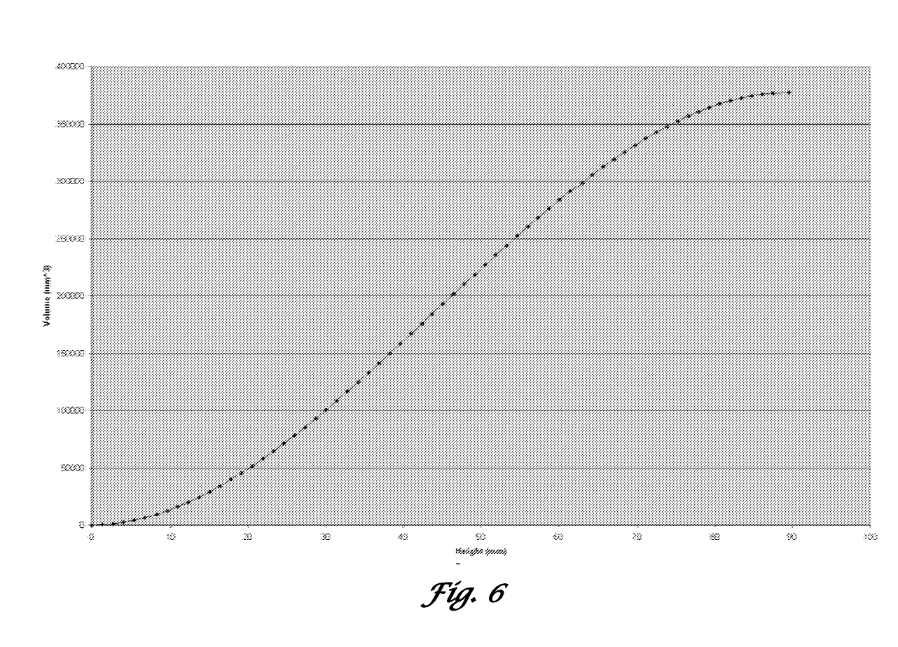

The user may need to analyze the inner volume while the solid model assembly is in a different orientation. When a different orientation is specified, the highest and lowest point of the voxels in the new direction is calculated. The highest and lowest points then become part of a new volume boundary cubes set. In the presently preferred embodiment, the user sets-up a sample point to gauge the volume. The number of the sample points depends upon the cube size. A data structure, VolumeHeightMap, traverses a loop to store any volume information at each sample point to the VolumeBoudarySet and the VolumeSet. Based on the VolumeHeightMap a Volume-Height graph can be generated by any graph program that has charting capabilities, as illustrated in FIG. 6. Based on the data structure VolumeHeightMap, the corresponding height (or volume) value of the user specified volume (or height) can be queried. If the height value is not at the sample point, an approximation by linear interpolation may be utilized to obtain accurate results.

### Step 6

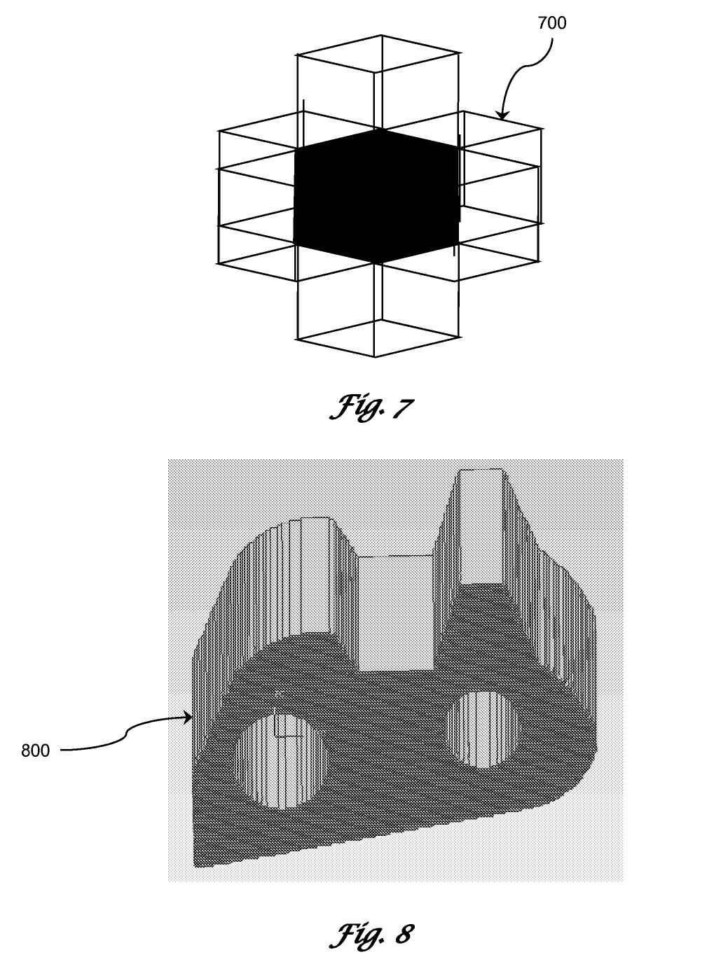

FIG. 7 is a facet model of an inner volume. Referring to FIG. 7, the inner volume of the solid model assembly can be represented with a facet model 700. The facet model 700 is generated from the VolumeSet data structure. To create the facet model 700, traverse by a loop operation all of the cubes in the VolumeSet by searching the adjacent cubes in six directions corresponding to the six faces for each cube. The original cube is at [I, J, K], defined by: [I−1, J, K], [I+1, J, K], [I, J−1, K], [I, J+1, K], [I, J, K−1], [I, J, K+1], where I, J, K is the index of the original cube in the x, y, z axis direction. Next, check the six cubes individually to determine if they are in the inner volume cube set, and if not, then the individual cube is on the outer face and will be used to create a surface of the facet. Then, create the facet model 700 as the internal volume for visual output to the user.

### Step 7

FIG. 8 is an illustration of a solid model for an internal volume. Referring to FIG. 8, an internal volume solid model 800 is generated based upon the data found in the VolumeBoudarySet and VolumeSet data structures. In the presently preferred embodiment, begin by dividing the assembly space into a number of layers, where each layer consists of one section, or row, of cubes. Next, search the outer boundary cubes in every layer in the same manner as described in Step 6, without factoring the up and down direction of cubes, i.e., limiting the cube selection to only those in the current layer. Search the outer face of each out boundary cube and store the two points of the base edge and the relationship between those two points in a PointSet data structure. Next, find the outline loop by circulating the PointSet because the process of finding the a point from its relationship to another point when done iteratively, results in a loop until the outline is complete. Following the outline loop, the loop is offset by half a cube size, in case there is non-manifold solid generated. The loop is extruded to the next layer where there is now cube-height plus a tolerance, creating in a layer of solid. Once all of the solid layers are united, the internal volume solid model 800 is generated. An alternative method to generate the internal volume solid model 800 is by creating an outer surface of the inner volume. To begin, obtain all boundary cubes of the voxel model of the internal volume. Next, find all outer faces of the boundary cubes thereby creating a 4-sided-shape planar surface. Now, sew the outer faces into a solid model resulting in the internal volume solid model 800.

### CONCLUSION

From Step 1 through Step 7, the presently preferred embodiment has disclosed a complete solution for calculating the internal volume of a solid model. The presently preferred embodiment may be implemented in digital electronic circuitry, or in computer hardware, firmware, software, or in combinations thereof. An apparatus of the presently preferred embodiment may be implemented in a computer program product tangibly embodied in a machine-readable storage device for execution by a programmable processor; and method steps of the presently preferred embodiment may be performed by a programmable processor executing a program of instructions to perform functions of the presently preferred embodiment by operating on input data and generating output.

The presently preferred embodiment may advantageously be implemented in one or more computer programs that are executable on a programmable system including at least one programmable processor coupled to receive data and instructions from, and to transmit data and instructions to, a data storage system, at least one input device, and at least one output device. The application program may be implemented in a high-level procedural or object-oriented programming language, or in assembly or machine language if desired; and in any case, the language may be a compiled or interpreted language.

Generally, a processor will receive instructions and data from a read-only memory and/or a random access memory. Storage devices suitable for tangibly embodying computer program instructions and data include all forms of nonvolatile memory, including by way of example semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, specially-designed ASICs (application2-specific integrated circuits).

A number of embodiments have been described. It will be understood that various modifications may be made without departing from the spirit and scope of the presently preferred embodiment. It is contemplated that the user may define a solid model to hold a fluid reservoir such as oil or gasoline or water. The volume of the fluid reservoir may be determined or selected based upon its characteristics. Further, the volume space to be modeled can be selected by other characteristics such as fluid flow for example by a vacuum cleaner or other wind-tunnel. Therefore, other implementations are within the scope of the following claims.

What is claimed is:

1. A computer implemented method for calculating internal volume of a solid model, comprising:
selecting a seed cube that is internal to a solid model;
determining a plurality of surrounding cubes surrounding said seed cube; and
calculating a boundary volume from said plurality of surrounding cubes.

2. The method of claim 1, further comprising generating an internal volume solid model from said boundary volume.

3. The method of claim 1, further comprising orienting said boundary volume to coincide with an orientation of said solid body to formulate a volume height map.

4. The method of claim 3, further comprising generating a volume height graph from said volume height map.

5. The method of claim 4, further comprising determining whether a height value on said volume height map is at a sample point.

6. The method of claim 1, wherein said seed cube is determined by a selection mechanism.

7. The method of claim 1, wherein said seed cube is determined based upon a predefined property.

8. The method of claim 1, wherein said predefined property is a fluid reservoir.

9. The method of claim 1, further comprising refining to reduce said plurality of boundary cubes.

10. The method of claim 1, further comprising generating a facet model for said volume.

11. The method of claim 10, wherein said facet model is created from a plurality of inner boundary faces.

12. A computer-program product tangibly embodied in a machine readable medium to perform a method for calculating internal volume of a solid model, comprising instructions operable to cause a computer to:
select a seed cube that is internal to a solid model;
determine a plurality of surrounding cubes surrounding said seed cube; and
calculate a boundary volume from said plurality of surrounding cubes.

13. The computer-program product of claim 12, further comprising instructions to generate an internal volume solid model from said boundary volume.

14. The computer-program product of claim 12, further comprising instructions to orient said boundary volume to coincide with an orientation of said solid body to formulate a volume height map.

15. The computer-program product of claim 14, further comprising instructions to generate a volume height graph from said volume height map.

16. The computer-program product of claim 15, further comprising instructions to determine whether a height value on said volume height map is at a sample point.

17. The computer-program product of claim 12, wherein said seed cube is determined by a selection mechanism.

18. The computer-program product of claim 12, wherein said seed cube is determined based upon a predefined property.

19. The computer-program product of claim 12, wherein said predefined property is a fluid reservoir.

20. The computer-program product of claim 12, further comprising refining to reduce said plurality of boundary cubes.

21. The computer-program product of claim 12, further comprising generating a facet model for said volume.

22. The computer-program product of claim 21, wherein said facet model is created from a plurality of inner boundary faces.

23. A computer implemented method for calculating internal volume of a solid model, comprising:
generating a voxel model of a space internal to a solid model;
traversing said voxel model to determine a boundary volume having a plurality of boundary cubes;
calculating a volume of said boundary volume;
whereby said calculated volume is a depiction of said space internal.

24. A data processing system having at least a processor and accessible memory to implement a method for calculating internal volume of a solid model, comprising:
means for selecting a seed cube that is internal to a solid model;
means for determining a plurality of surrounding cubes surrounding said seed cube; and
means for calculating a boundary volume from said plurality of surrounding cubes.
